(19) United States
(12) Patent Application Publication
(10) Pub. No.: US 2024/0320398 A1
(43) Pub. Date: Sep. 26, 2024

(54) MULTISCALE ANALYSIS METHOD, SYSTEM, MEDIA AND DEVICE FOR THERMAL-MECHANICAL COUPLING PERFORMANCE OF HEAT EXCHANGER

(71) Applicant: Xi'an Jiaotong University, Xi'an (CN)

(72) Inventors: Ting Ma, Xi'an (CN); Zirui Xu, Xi'an (CN); Yin Tan, Xi'an (CN); Xiaoxu Zhang, Xi'an (CN); Qiyuan Ma, Xi'an (CN); Wangnan Chen, Xi'an (CN); Min Zeng, Xi'an (CN); Qiuwang Wang, Xi'an (CN)

(21) Appl. No.: 18/736,442

(22) Filed: Jun. 6, 2024

(30) Foreign Application Priority Data
Jun. 8, 2023 (CN) 202310675605.X

(51) Int. Cl. G06F 30/23; G06F 30/17; G06F 111/10

(52) U.S. Cl. CPC G06F 30/23; G06F 30/17; F28F 2200/00; G06F 2111/10

(57) ABSTRACT

The present invention belongs to the field of heat exchanger design and analysis, and discloses a multiscale analysis method, system, media and device for thermal-mechanical coupling performance of a heat exchanger, and the method comprises: performing zone division on the heat exchanger, and establishing channel unit cell models for respective zones; calculating equivalent mechanical parameters by constructing equations for equivalent stiffness coefficients and flexibility coefficients with respect to deformation energy, setting nodal displacement constraints or performing unit strain and stress loading; constructing an equivalent model, and calculating a macroscopic stress field, a strain field and a displacement field of the whole heat exchanger under temperature and pressure loads under operating conditions, calculating microscopic stress field of mesoscale channels at locations of weak strength zones of the heat exchanger. The present invention can provide theoretical and methodological guidance for strength design and application of high-temperature and high-pressure heat exchangers.

### TECHNICAL FIELD

The present invention belongs to the field of heat exchanger design and analysis, and more particularly pertains to a multiscale analysis method and system for thermal-mechanical coupling performance of plate and plate-fin heat exchangers.

### BACKGROUND

At present, heat exchangers, as major devices for improving energy efficiency, have been paid more and more attention. The heat exchangers are core devices of industrial thermal management systems, and are widely used in aerospace, shipbuilding, nuclear energy, chemical industry and other industrial sectors. The heat exchangers transfer heat from high-temperature side fluids to low-temperature side fluids to bring fluid temperature to process specifications and improve energy utilization. However, to further improve thermal efficiency, the heat exchangers are often required to be in high-temperature and high-pressure environments, which poses challenges to their structural reliability.

At present, strength design of heat exchangers generally complies with heat exchanger industry specifications and standards. However, when relatively complex heat exchange channels or high-temperature and high-pressure operating conditions are involved, design methods based on the specifications and standards will no longer accommodate, and the design methods based on the specifications and standards can not accurately describe stress conditions at intersections of different channel types in a same heat exchanger (e.g., an intersection between inlet and outlet structures and a core structure of a main heat exchange zone). However, due to change of the channel type, stress field distribution here changes dramatically, which can easily result in plastic deformation and fatigue failure of materials. Meanwhile, for the whole heat exchanger, shapes and thicknesses of cover plates and side plates thereof have a great impact on stress deformation behaviors of the core structure inside the heat exchanger. Therefore, it is necessary to use a numerical analysis method to accurately describe the stress deformation behaviors of the whole heat exchanger. However, considering that the heat exchangers usually consist of tens of thousands or even hundreds of thousands of tiny channels, it is not possible to complete modeling and calculations for such complex models using conventional numerical analysis methods.

Based on the above analysis, problems and defects of the prior art are that the prior art is unable to model and calculate actual size heat exchanger models under temperature and pressure loads, and inaccurately describes the stress deformation behaviors of the heat exchangers.

### SUMMARY

In view of the problems of the prior art, the present invention provides a multiscale analysis method and system for thermal-mechanical coupling performance of a heat exchanger.

The present invention is realized as follows: a multiscale analysis method for thermal-mechanical coupling performance of a heat exchanger, comprises:

performing zone division on the heat exchanger, and establishing channel unit cell models for respective zones; calculating equivalent mechanical parameters of channels in different zones of the heat exchanger by constructing form equations for equivalent stiffness coefficients and flexibility coefficients of heat exchanger channels with respect to deformation energy, setting nodal displacement constraints and performing unit strain and stress loading; constructing a macroscale heat exchanger equivalent solid model, and calculating a macroscopic stress field, a strain field and a displacement field of the whole heat exchanger under a combined action of a temperature load and a pressure load under operating conditions based on the macroscale heat exchanger equivalent solid model to obtain a microscopic stress field of mesoscale channels at locations of weak strength zones of the heat exchanger.

Further, the multiscale analysis method for thermal-mechanical coupling performance of a heat exchanger comprises the following steps:
Step 1, dividing the heat exchanger into an inlet zone, an outlet zone, a core zone and a cover plate zone according to channel structural characteristics of an actual heat exchanger; and extracting a representative channel unit cell for each zone, and constructing channel unit cell finite element models for respective zones of the heat exchanger;
Step 2, dividing the heat exchanger channels into single-type channels and hybrid-type channels, establishing form equations for corresponding equivalent stiffness coefficient matrices or flexibility coefficient matrices with respect to the deformation energy respectively, and calculating equivalent mechanical parameters of the channels in different zones of the heat exchanger by setting a corresponding nodal displacement constraint equation and performing characteristic unit strain or stress loading;
Step 3, establishing a macroscale heat exchanger equivalent solid model, and taking the calculated equivalent mechanical parameters of the channels in the different zones of the heat exchanger as material properties of the heat exchanger equivalent solid model;
Step 4, introducing heat exchanger temperature field data into the heat exchanger equivalent solid model to load a heat exchanger temperature load; setting new equivalent thermal expansion coefficients for equivalent solid models of cold channels and hot channels of the heat exchanger respectively, applying a fixed temperature difference and a uniform pressure to load the pressure load of the heat exchanger, and calculating a macroscopic stress field, a strain field and a displacement field of the whole heat exchanger under a combined action of the temperature load and the pressure load under operating conditions; and
Step 5, determining locations of weak strength zones of the heat exchanger according to calculation results of the macroscopic stress field, the strain field and the displacement field of the heat exchanger equivalent solid model; combining calculation results of unit characteristic stress, strain and temperature field loading of the channel unit cell in each zone of the heat exchanger, and calculating a stress amplification coefficient matrix to obtain the microscopic stress field of mesoscale channels at the locations of the weak strength zones of the heat exchanger.

Further, the Step 2 comprises:
(1) for core zone channels with the same cold and hot channel structure in the heat exchanger which are regarded as the single-type channels with periodic distribution characteristics, by setting a periodic characteristic strain field χ*^{(ij)}, taking the unit characteristic strain field and a strain field caused by unit cell heterogeneity as characteristic strain fields directly applied to a boundary, and obtaining simplified mathematical equations for the equivalent stiffness coefficients of the single-type channels based on form of deformation energy Π;
(2) for inlet and outlet zone channels with different cold and hot channel structures in the heat exchanger which are regarded as the hybrid-type channels with partially periodical distribution characteristics, by setting partial periodic characteristic strain fields \tilde{χ}*^{(ij)} and \tilde{ξ}*^{(ij)} respectively, taking the unit characteristic strain field and a unit characteristic stress field as well as the strain field caused by unit cell heterogeneity as characteristic strain fields directly applied to a channel unit cell boundary, and obtaining simplified mathematical equations for an upper limit and a lower limit of the equivalent stiffness coefficients of the hybrid-type channels based on form of deformation energy Π;
(3) for the cover plate zone of the heat exchanger: selecting a substrate and recording material properties of the substrate at different temperatures; and
(4) calculating by the infinite element method the simplified mathematical equations for the equivalent stiffness coefficients of the single-type channels based on form of deformation energy Π and the simplified mathematical equations for the upper limit and the lower limit of the equivalent stiffness coefficients of the hybrid-type channels based on form of deformation energy Π, so as to calculate the equivalent mechanical parameters of the channels in the different zones of the heat exchanger at different temperatures.

Further, the simplified mathematical equations for the equivalent stiffness coefficients Dᵢⱼₖₗ^{H} of the single-type channels based on form of deformation energy Π are as follows:
diagonal stiffness coefficient

$${D}_{ijij}^{H} = \frac{2}{\vert Y \vert} Π ( {χ}^{* ( ij )} ) ;$$

off-diagonal stiffness coefficient:

$${D}_{iikl}^{H} = \frac{1}{\vert Y \vert} [ Π ( {χ}^{* ( ii )} + {χ}^{* ( kl )} ) - Π ( {χ}^{* ( ii )} ) - Π ( {χ}^{* ( kl )} ) ] ;$$

where χ*^{(ij)} is a periodic unit characteristic strain field; i, j, k, l=1, 2, 3 and are all direction vectors; |Y| is a unit cell volume; and Π is deformation energy.

The simplified mathematical equations for the upper limit and the lower limit of the equivalent stiffness coefficients of the single-type channels based on form of deformation energy Π are as follows:
(2.1) for energy form equations for the upper limit of the equivalent stiffness coefficients:
diagonal stiffness coefficient

$${D}_{ijij}^{H} = \frac{2}{\vert Y \vert} Π ( {{χ}^{○}}^{* ( ij )} ) ;$$

off-diagonal stiffness coefficient

$${D}_{iikl}^{H} = \frac{1}{\vert Y \vert} [ Π ( {{χ}^{○}}^{* ( ii )} + {{χ}^{○}}^{* ( kl )} ) - Π ( {{χ}^{○}}^{* ( ii )} ) - Π ( {{χ}^{○}}^{* ( kl )} ) ] ;$$

where χ̊*^{ij} represents a partially periodic unit characteristic strain field; i, j, k, l are all direction vectors with values of 1, 2 and 3; |Y| is a unit cell volume; and Π is deformation energy.
(2.2) for energy form equations for the lower limit of the equivalent stiffness coefficients:
diagonal flexibility coefficient:

$${S}_{ijij}^{H} = \frac{2}{\vert Y \vert} Π ( {{ξ}^{\%}}^{( ij )} ) ;$$

off-diagonal flexibility coefficient:

$${S}_{iikl}^{H} = \frac{1}{\vert Y \vert} [ Π ( {{ξ}^{\%}}^{( ii )} + {{ξ}^{\%}}^{( kl )} ) - Π ( {{ξ}^{\%}}^{( ii )} ) - Π ( {{ξ}^{\%}}^{( kl )} ) ] ;$$

the lower limit of the equivalent stiffness coefficient: Dᵢⱼₖₗ^{H}=(Sᵢⱼₖₗ^{H})⁻¹;
where [symbol] represents a characteristic strain field corresponding to the partially periodic unit characteristic stress field; i, j, k, l are all direction vectors with values of 1, 2 and 3; |Y| is a unit cell volume; and Π is deformation energy.

The equivalent mechanical performance parameters of the heat exchanger channels are as follows:

$$[ {S}_{ijkl}^{H} ] = [ \begin{matrix}{S}_{1111}^{H} & {S}_{1122}^{H} & {S}_{1133}^{H} & 0 & 0 & 0 \\ {S}_{1122}^{H} & {S}_{2222}^{H} & {S}_{2233}^{H} & 0 & 0 & 0 \\ {S}_{1133}^{H} & {S}_{2233}^{H} & {S}_{3333}^{H} & 0 & 0 & 0 \\ 0 & 0 & 0 & {S}_{1212}^{H} & 0 & 0 \\ 0 & 0 & 0 & 0 & {S}_{1313}^{H} & 0 \\ 0 & 0 & 0 & 0 & 0 & {S}_{2323}^{H}\end{matrix} ] = {[ {D}_{ijkl}^{H} ]}^{- 1} = [ \begin{matrix}\frac{1}{{E}_{x}} & - \frac{{V}_{xy}}{{E}_{x}} & - \frac{{V}_{xz}}{{E}_{x}} & 0 & 0 & 0 \\ - \frac{{V}_{yx}}{{E}_{y}} & \frac{1}{{E}_{y}} & - \frac{{V}_{yz}}{{E}_{y}} & 0 & 0 & 0 \\ - \frac{{V}_{zx}}{{E}_{z}} & - \frac{{V}_{zy}}{{E}_{z}} & \frac{1}{{E}_{z}} & 0 & 0 & 0 \\ 0 & 0 & 0 & \frac{1}{{G}_{xy}} & 0 & 0 \\ 0 & 0 & 0 & 0 & \frac{1}{{G}_{xz}} & 0 \\ 0 & 0 & 0 & 0 & 0 & \frac{1}{{G}_{yz}}\end{matrix} ]$$

Further, taking the calculated equivalent mechanical parameters of the channels in the different zones of the heat exchanger as material properties of the heat exchanger equivalent solid model comprises:

Taking the calculated equivalent mechanical parameters of the channels in each zone of the heat exchanger as the equivalent material properties of a corresponding zone in the heat exchanger equivalent solid model, and perform matrix direction transformation when the material properties of the different zones are introduced into the macroscale heat exchanger equivalent solid model.

The material properties comprise three equivalent elastic moduli as a function of temperature, three equivalent shear moduli as a function of temperature, and three equivalent Poisson's ratios as a function of temperature.

Further, the Step 4 comprises:
(1) introducing the temperature field data of the heat exchanger into the heat exchanger equivalent solid model to load the heat exchanger temperature load;
(2) setting new equivalent thermal expansion coefficients αₓ^{H}(T) and α_{y}^{H}(T) for the cold and hot channels in an x direction and a y direction of the equivalent solid models of the cold and hot channels respectively, applying a fixed temperature difference ΔT to an overall temperature field of the heat exchanger; wherein the equivalent thermal expansion coefficients are related to the equivalent flexibility coefficient Sᵢⱼₖₗ^{H} of the heat exchanger channels, a flexibility coefficient Sᵢⱼₖₗ of raw materials, temperature T and a heat exchanger channel pressure P;
(3) applying a uniform pressure of value P(1−Ø) to an inlet and outlet cross-section in a z direction and loading an equivalent pressure load of the heat exchanger; wherein Ø represents porosity; and
(4) calculating the macroscopic stress field, the strain field and the displacement field of the whole heat exchanger under the combined action of the temperature load and the pressure load under the operating conditions using the following equation:

$$\{ \begin{matrix}{α}_{x}^{H} ( T ) \\ {α}_{y}^{H} ( T )\end{matrix} \} = {P}_{h , c} \{ \begin{matrix}{S}_{1111}^{H} ( T ) + {S}_{1122}^{H} ( T ) - {S}_{1111} ( T ) - {S}_{1122} ( T ) \\ {S}_{1122}^{H} ( T ) + {S}_{2222}^{H} ( T ) - {S}_{1122} ( T ) - {S}_{2222} ( T ) )\end{matrix} \} / Δ T ,$$

where superscript Π represents equivalent; ax (T) and ay (T) represent the equivalent thermal expansion coefficients in the x direction and the y direction respectively; P_{c} and Pₕ represent a cold side pressure and a hot side pressures respectively, subscripts c and h represent a cold side and a hot side respectively; Sᵢⱼₖₗ^{H} represents the equivalent flexibility coefficient, i, j, k and l represent direction vectors with values of 1, 2 and 3; Sᵢⱼₖₗ represents the equivalent flexibility coefficient of the raw materials; T represents temperature; and ΔT represents the temperature difference.

Another object of the present invention is to provide a multiscale analysis system for thermal-mechanical coupling performance of a heat exchanger implementing the multiscale analysis method for thermal-mechanical coupling performance of a heat exchanger, and the multiscale analysis system for thermal-mechanical coupling performance of a heat exchanger comprises:
a heat exchanger channel unit cell finite element model construction module configured to divide the heat exchanger into an inlet zone, an outlet zone, a core zone and a cover plate zone according to channel structural characteristics of an actual heat exchanger, and extract a representative channel unit cell for each zone to construct channel unit cell finite element models for respective zones of the heat exchanger;
a heat exchanger channel equivalent mechanical parameter calculation module configured to divide the heat exchanger channels into single-type channels and hybrid-type channels, establish form equations for corresponding equivalent stiffness coefficient matrices or flexibility coefficient matrices with respect to deformation energy respectively, and calculate equivalent mechanical parameters of the channels in different zones of the heat exchanger by setting a corresponding nodal displacement constraint equation and performing characteristic unit strain or stress loading;
a heat exchanger equivalent solid model construction module configured to establish a macroscale heat exchanger equivalent solid model, and take the calculated equivalent mechanical parameters of the channels in the different zones of the heat exchanger as material properties of the heat exchanger equivalent solid model;
a heat exchanger macroscopic stress-strain calculation module configured to introduce heat exchanger temperature field data into the heat exchanger equivalent solid model to load a heat exchanger temperature load, set new equivalent thermal expansion coefficients for equivalent solid models of cold channels and hot channels of the heat exchanger respectively, apply a fixed temperature difference and a uniform pressure to load a pressure load of the heat exchanger, and calculate a macroscopic stress field, a strain field and a displacement field of the whole heat exchanger under a combined action of the temperature load and the pressure load under operating conditions; and
a heat exchanger microscopic stress field calculation module configured to determine locations of weak strength zones of the heat exchanger according to calculation results of the macroscopic stress field, the strain field and the displacement field of the heat exchanger equivalent solid model, combine calculation results of unit characteristic stress, strain and temperature field loading of the channel unit cell in each zone of the heat exchanger, and calculate a stress amplification coefficient matrix to obtain a microscopic stress field of mesoscale channels at the locations of the weak strength zones of the heat exchanger.

A further object of the present invention is to provide a computer device comprising a memory and a processor, wherein the memory stores a computer program which, when executed by the processor, causes the processor to perform the steps of the multiscale analysis method for thermal-mechanical coupling performance of a heat exchanger.

A still further object of the present invention is to provide a computer-readable storage medium storing a computer program which, when executed by a processor, causes the processor to perform the steps of the multiscale analysis method for thermal-mechanical coupling performance of a heat exchanger.

A yet still further object of the present invention is to provide an information data processing terminal for implementing the multiscale analysis system for thermal-mechanical coupling performance of a heat exchanger.

In combination with the technical solutions and the technical problems solved as described above, the claimed technical solutions of the present invention have the following advantages and positive effects:

First, by transforming the complex thermal-mechanical coupling problem of the actual heat exchanger model into a simple thermal-mechanical coupling problem of the heat exchanger equivalent solid model, the present invention avoids direct modeling and meshing of the heat exchanger composed of hundreds of thousands of microchannels, which can greatly reduce the difficulty of geometric modeling and number of meshes for thermal-mechanical coupling calculation of the heat exchanger, and greatly reduces calculation time.

In the present invention, a “unit-core-heat exchanger” thermal-mechanical coupling multiscale numerical analysis model, and a new equivalent thermal expansion coefficient is proposed for the equivalent solid models of the cold channels and the hot channels of the heat exchanger respectively, which can solve the macroscopic stress field, the strain field and the displacement field of the actual size heat exchanger under the combined action of temperature and pressure, and effectively reduce the difficulty of applying the pressure load during a heat exchanger modeling stage.

In the present invention, the concept of the stress amplification coefficient matrix is proposed, and the microscopic stress field of the mesoscale heat exchanger channels are calculated according to the macroscopic stress field results of the whole heat exchanger on a macroscale, which can accomplish strength check of the heat exchanger under simultaneous action of temperature and pressure.

Second, in the present invention, the core and inlet and outlet zones of the heat exchanger are equated as homogeneous solid materials. By applying the actual temperature and pressure loads to the heat exchanger equivalent solid model, distribution of the stress field, the strain field and the displacement field of the whole heat exchanger under the operating conditions can be calculated. The present invention enables calculation and analysis of the stress field, the strain field and the displacement field of the actual size heat exchanger, and reveal the mechanism of influence of external factors such as high temperature and high pressure on stress and deformation characteristics of typical heat exchanger channels, which provides theoretical and methodological guidance for the design and application of high-temperature and high-pressure heat exchangers.

Third, in the present invention, the “unit-core-heat exchanger” thermal-mechanical coupling multiscale numerical analysis model, and a new equivalent thermal expansion coefficient is proposed for the equivalent solid models of the cold channels and the hot channels of the heat exchanger respectively, which can solve the macroscopic stress field, the strain field and the displacement field of the actual size heat exchanger under the combined action of temperature and pressure, and effectively reduce the difficulty of applying the pressure and temperature loads during a heat exchanger modeling stage, thus calculating the distribution of the stress field, the strain field and the displacement field of the whole heat exchanger under the operating conditions.

### BRIEF DESCRIPTION OF THE DRAWINGS

FIG. 1 is a schematic diagram of a multiscale analysis method for thermal-mechanical coupling performance of a heat exchanger according to an embodiment of the present invention; and

FIG. 2 is a schematic diagram of heat exchanger zone division and channel unit cell models for inlet and outlet, core and cover plate zones according to an embodiment of the present invention.

### DESCRIPTION OF THE EMBODIMENTS

To make the objects, the technical solution and advantages of the present invention more clear, the present invention will be further described in detail below in conjunction with embodiments. It should be understood that the specific embodiments described herein are merely illustrative of the present invention and are not meant to limit the present invention.

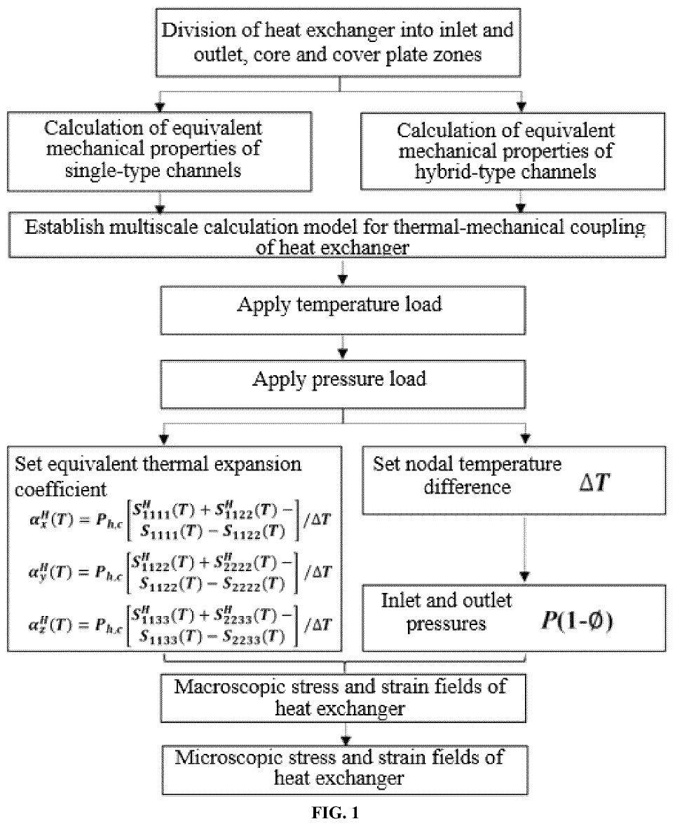

As shown in FIG. 1, a multiscale analysis method for thermal-mechanical coupling performance of a heat exchanger according to an embodiment of the present invention comprises the following steps:
S101, dividing the heat exchanger into an inlet zone, an outlet zone, a core zone and a cover plate zone according to channel structural characteristics of an actual heat exchanger; and extracting a representative channel unit cell for each zone, and constructing channel unit cell finite element models for respective zones of the heat exchanger;
S102, dividing the heat exchanger channels into single-type channels and hybrid-type channels, establishing form equations for corresponding equivalent stiffness coefficient matrices or flexibility coefficient matrices with respect to deformation energy respectively, and calculating equivalent mechanical parameters of the channels in different zones of the heat exchanger by setting a corresponding nodal displacement constraint equation and performing characteristic unit strain or stress loading;
S103, establishing a macroscale heat exchanger equivalent solid model, and taking the calculated equivalent mechanical parameters of the channels in the different zones of the heat exchanger as material properties of the heat exchanger equivalent solid model;
S104, introducing heat exchanger temperature field data into the heat exchanger equivalent solid model to load a heat exchanger temperature load; setting new equivalent thermal expansion coefficients for equivalent solid models of cold channels and hot channels of the heat exchanger respectively, applying a fixed temperature difference and a uniform pressure to load a pressure load of the heat exchanger, and calculate a macroscopic stress field, a strain field and a displacement field of the whole heat exchanger under a combined action of the temperature load and the pressure load under operating conditions; and
S105, determining locations of weak strength zones of the heat exchanger according to calculation results of the macroscopic stress field, the strain field and the displacement field of the heat exchanger equivalent solid model; combining calculation results of unit characteristic stress, strain and temperature field loading of the channel unit cell in each zone of the heat exchanger, and calculating a stress amplification coefficient matrix to obtain a microscopic stress field of mesoscale channels at the locations of the weak strength zones of the heat exchanger.

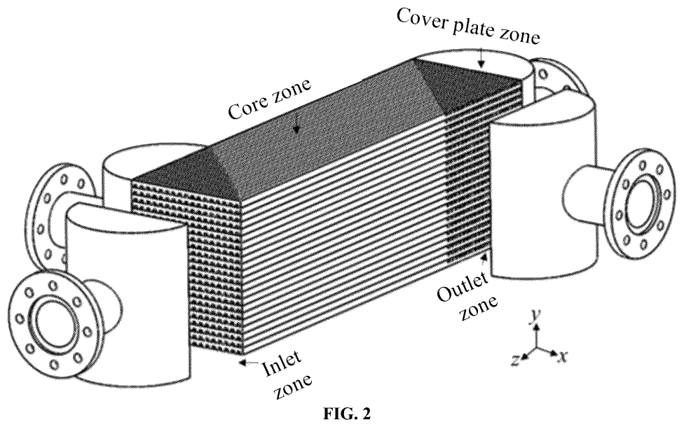

A multiscale analysis method for thermal-mechanical coupling performance of a heat exchanger according to an embodiment of the present invention specifically comprises:
Step 1, as shown in FIG. 2, dividing an actual heat exchanger into an inlet and outlet zone, a core zone and a cover plate zone according to structural characteristics of an actual heat exchanger; and extracting a representative channel unit cell for each zone, and constructing channel unit cell finite element models for respective zones of the heat exchanger;
Step 2, dividing heat exchanger channels into single-type channels and hybrid-type channels, wherein inlet and outlet channels are considered to have a partial periodic distribution characteristic, and core channels are considered to have a periodic distribution characteristic; and calculating equivalent mechanical parameters of the channels in different zones of the heat exchanger by setting a corresponding nodal displacement constraint equation and loading a characteristic unit strain or stress load.

The Step 2 specifically is as follows:
(1) for core zone channels with the same cold and hot channel structure: the core zone channels with the same cold and hot channel structure are regarded as single-type channels, by setting a periodic characteristic strain field χ*^{(ij)}, a unit characteristic strain field and a strain field caused by unit cell heterogeneity are considered as characteristic strain fields directly applied to a boundary to derive simplified mathematical equations for equivalent stiffness coefficients of the single-type core channels based on form of deformation energy Π;
The step specifically is as follows:

The above two simplified mathematical equations are solved by the finite element method to further accomplish calculation of the equivalent mechanical parameters of the channels in the different zones of the heat exchanger at different temperatures.

By setting a periodic characteristic strain field χ*^{(ij)}, a unit test strain field and the strain field caused by unit cell heterogeneity are considered as unit characteristic strain fields directly applied to a channel unit cell boundary to derive simplified mathematical equations for the equivalent stiffness coefficients of core zone channel unit cells with the same cold and hot channel structure based on form of deformation energy as follows:
diagonal stiffness coefficient

$${D}_{ijij}^{H} = \frac{2}{\vert Y \vert} Π ( {χ}^{* ( ij )} ) ;$$

off-diagonal stiffness coefficient:

$${D}_{iikl}^{H} = \frac{1}{\vert Y \vert} [ Π ( {χ}^{* ( ii )} + {χ}^{* ( kl )} ) - Π ( {χ}^{* ( ii )} ) - Π ( {χ}^{* ( kl )} ) ] ;$$

where χ*^{(ij)} is a periodic unit characteristic strain field; i, j, k, l=1, 2, 3 and are all direction vectors; |Y| is a unit cell volume; and Π is deformation energy.
(2) for inlet and outlet zone channels with different cold and hot channel structures: the inlet and outlet zone channels with different cold and hot channel structures are regarded as hybrid-type channels. By setting partially periodic characteristic strain fields χ̊*^{(ij)} and [symbol] respectively, the unit characteristic strain field and a unit characteristic stress field as well as the strain field caused by unit cell heterogeneity are considered as characteristic strain fields directly applied to a boundary to derive simplified mathematical equations for an upper limit and a lower limit of the equivalent stiffness coefficients of the hybrid-type inlet and outlet zone channels based on form of deformation energy Π;

The step specifically is as follows:

By defining a partially periodic unit characteristic strain χ̊*^{(ij)} and the unit characteristic stress [symbol] respectively, a unit test strain field or stress field and the strain field caused by unit cell heterogeneity are considered as the characteristic strain fields directly applied to a channel unit cell boundary, and simplified solving equations for the upper limit and the lower limit of the equivalent stiffness coefficients of the hybrid-type channels with respect to the form of deformation energy is established.
(2.1) for energy form equations for the upper limit of the equivalent stiffness coefficients:
diagonal stiffness coefficient

$${D}_{ijij}^{H} = \frac{2}{\vert Y \vert} ( {{χ}^{○}}^{* ( ij )} ) ;$$

off-diagonal stiffness coefficient

$${D}_{iikl}^{H} = \frac{1}{\vert Y \vert} [ Π ( {\mathring{χ}}^{* ( ii )} + {\mathring{χ}}^{* ( kl )} ) - Π ( {\mathring{χ}}^{* ( ii )} ) - Π ( {\mathring{χ}}^{* ( kl )} ) ] ;$$

where χ̊*^{(ij)} represents a partially periodic unit characteristic strain field; i, j, k, l are all direction vectors with values of 1, 2 and 3; |Y| is a unit cell volume; and Π is deformation energy.
(2.2) for energy form equations for the lower limit of the equivalent stiffness coefficients:
diagonal flexibility coefficient:

$${S}_{ijij}^{H} = \frac{2}{\vert Y \vert} Π ( {{ξ}^{\%}}^{* ( ij )} ) ;$$

off-diagonal flexibility coefficient:

$${S}_{iikl}^{H} = \frac{1}{\vert Y \vert} [ Π ( {{ξ}^{\%}}^{* ( ii )} + {{ξ}^{\%}}^{* ( kl )} ) - Π ( {{ξ}^{\%}}^{* ( ii )} ) - Π ( {{ξ}^{\%}}^{* ( kl )} ) ] ;$$

the lower limit of the equivalent stiffness coefficient: Dᵢⱼₖₗ^{H}=(Sᵢⱼₖₗ^{H})⁻¹;
where [symbol] represents a characteristic strain field corresponding to the partially periodic unit characteristic stress field; i, j, k, l are all direction vectors with values of 1, 2 and 3; |Y| is a unit cell volume; and Π is deformation energy.

Based on this, the equivalent mechanical parameters of the heat exchanger channels are obtained:

$$[ {S}_{ijkl}^{H} ] = [ \begin{matrix}{S}_{1111}^{H} & {S}_{1122}^{H} & {S}_{1133}^{H} & 0 & 0 & 0 \\ {S}_{1122}^{H} & {S}_{2222}^{H} & {S}_{2233}^{H} & 0 & 0 & 0 \\ {S}_{1133}^{H} & {S}_{2233}^{H} & {S}_{3333}^{H} & 0 & 0 & 0 \\ 0 & 0 & 0 & {S}_{1212}^{H} & 0 & 0 \\ 0 & 0 & 0 & 0 & {S}_{1313}^{H} & 0 \\ 0 & 0 & 0 & 0 & 0 & {S}_{2323}^{H}\end{matrix} ] = {[ {D}_{ijkl}^{H} ]}^{- 1} = [ \begin{matrix}\frac{1}{{E}_{x}} & - \frac{{V}_{xy}}{{E}_{x}} & - \frac{{V}_{xz}}{{E}_{x}} & 0 & 0 & 0 \\ - \frac{{V}_{yx}}{{E}_{y}} & \frac{1}{{E}_{y}} & - \frac{{V}_{yz}}{{E}_{y}} & 0 & 0 & 0 \\ - \frac{{V}_{zx}}{{E}_{z}} & - \frac{{V}_{zy}}{{E}_{z}} & \frac{1}{{E}_{z}} & 0 & 0 & 0 \\ 0 & 0 & 0 & \frac{1}{{G}_{xy}} & 0 & 0 \\ 0 & 0 & 0 & 0 & \frac{1}{{G}_{xz}} & 0 \\ 0 & 0 & 0 & 0 & 0 & \frac{1}{{G}_{yz}}\end{matrix} ]$$

(3) for the cove plate zone: a substrate Inconel 718 is selected and the material properties at different temperatures are recorded.

Step 3, establishing a heat exchanger equivalent solid model, wherein the equivalent model comprises a core zone, an inlet and outlet zone and a cover plate zone; and taking the equivalent mechanical parameters calculated in the Step 2 as material properties of the heat exchanger equivalent solid model, wherein each zone of the heat exchanger equivalent solid model has different equivalent material properties. Here, the established heat exchanger equivalent solid model and the actual heat exchanger model have the same zone division, each zone of the heat exchanger equivalent solid model has different equivalent material properties, the material properties are calculated in the Step 2, comprising three equivalent elastic moduli E(T) as a function of temperature, three equivalent shear moduli G(T) as a function of temperature and three equivalent Poisson's ratios V(T) as a function of temperature, and when the material properties of the different zones are introduced into the macroscale heat exchanger equivalent solid model, matrix direction transformation should be performed.

Step 4, introducing heat exchanger temperature field data into the heat exchanger equivalent solid model established in the Step 3 to load the heat exchanger temperature load; and then setting new equivalent thermal expansion coefficients αₓ^{H}(T) and α_{y}^{H}(T) for equivalent solid models of cold channels and hot channels respectively, applying a fixed temperature difference to the whole heat exchanger temperature field, and applying a uniform pressure of value P(1−Ø) to an inlet and outlet cross-section in a z direction to load an equivalent pressure load of the heat exchanger; where Ø represents porosity; thus accomplishing calculation of a macroscopic stress field, a strain field and a displacement field of the whole heat exchanger under a combined action of the temperature load and the pressure load under operating conditions:

$$\{ \begin{matrix}{α}_{x}^{H} ( T ) \\ {α}_{y}^{H} ( T )\end{matrix} \} = {P}_{h , c} \{ \begin{matrix}{S}_{1111}^{H} ( T ) + {S}_{1122}^{H} ( T ) - {S}_{1111} ( T ) - {S}_{1122} ( T ) \\ {S}_{1122}^{H} ( T ) + {S}_{2222}^{H} ( T ) - {S}_{1122} ( T ) - {S}_{2222} ( T ) )\end{matrix} \} / Δ T$$

where superscript H represents equivalent; αₓ^{H}(T) and α_{y}^{H}(T) represent the equivalent thermal expansion coefficients in the x direction and the y direction respectively; P_{c} and Pₕ represent a cold side pressure and a hot side pressures respectively, subscripts c and h represent a cold side and a hot side respectively; Sᵢⱼₖₗ^{H} represents the equivalent flexibility coefficient, i, j, k and l represent direction vectors; Sᵢⱼₖₗ represents the equivalent flexibility coefficient of the raw material; T represents temperature; and A T represents the temperature difference.

The equivalent thermal expansion coefficients are related to the equivalent flexibility coefficient Sᵢⱼₖₗ^{H} of the heat exchanger channels, a flexibility coefficient Sᵢⱼₖₗ of raw materials, temperature T and a heat exchanger channel pressure P. By setting the fixed temperature difference ΔT and applying the uniform pressure of value P(1−Ø) to the inlet and outlet in the z direction, the calculation of the macroscopic stress field, strain field and displacement field of the whole heat exchanger under the combined action of temperature and pressure under sudden operating conditions and at large temperature difference and large pressure difference can be completed, and the difficulty of applying the pressure load during a heat exchanger modeling stage can be effectively reduced.

Step 5, according to results of the macroscopic stress field, the strain field and the displacement field of the heat exchanger equivalent model, finding out locations of weak strength zones of the heat exchanger, solving a microscopic stress field of mesoscale channels at the locations by calculating a stress amplification coefficient matrix, and using a stress linearization method to complete strength check of the heat exchanger.

Solving the microscopic stress field of the mesoscale channels at the locations by calculating the stress amplification coefficient matrix comprises: combining calculation results of unit characteristic stress, strain and temperature field loading of a channel unit cell in each zone of the heat exchanger to complete calculation of the stress amplification coefficient matrix, thus solving the microscopic stress field of the mesoscale channels of the heat exchanger.

The Step 5 comprises the following specific steps:
(1) Outputting and obtaining stress distribution of the unit cells of the inlet and outlet channels and the core channel in the Step 2 under loading conditions of each characteristic unit stress load, calculating and deriving a ratio of a stress component of each node of the channel unit cell to the applied unit stress by finite element, and constructing the stress amplification coefficient matrix K for macroscopic and microscopic multi-scale transformation:

$${k}_{ij} = \frac{{σ}_{ij}}{{σ}_{0 j}}$$

where i=1˜6 represents each stress component, and j=1˜6 represents each loading.

For solving the stress amplification matrix K under the temperature load, 1° C. temperature rise condition is given to each node of the heat exchanger channel unit cell to derive a ratio of the stress component of each node of the channel unit cell to a macroscopic stress component caused by the 1° C. temperature rise applied.

$$Q = α \cdot Δ T$$

Where Q is a thermal stress, a is the thermal expansion coefficient of the material, and T is temperature of the material.
(2) multiplying the macroscopic stress of each node in the equivalent heat exchanger model by the calculated stress amplification coefficient matrix K to obtain microscopic stress distribution of the mesoscale channels in the inlet and outlet zone and the core zone.

In order to prove the inventive step and technical value of the technical solutions of the present invention, this section describes application embodiments of the technical solutions of the claims on specific products or related technologies.

The multiscale analysis method for thermal-mechanical coupling performance of a heat exchanger established in the embodiments of the present invention can be applied to structural design of plate-fin heat exchangers.

An error of the maximum mechanical stress value between the actual model and the equivalent model of the heat exchangers may be less than 7%. An error of the maximum thermal stress value between the actual model and the equivalent model of the heat exchangers may be less than 4%. The present invention avoids direct modeling and meshing of complex microchannel structures of the plate-fin heat exchangers, simplifies geometric modeling of the whole heat exchanger and reduces the number of meshes, and saves computational resources.

As a specific application of the preferred embodiment, the multiscale analysis method and system for thermal-mechanical coupling performance of a heat exchanger according to the embodiments of the present invention can be applied to design and optimization of various types of plate-fin heat exchanger product. For example, the multiscale analysis method and system can be applied to various plate and plate-fin heat exchanger devices used in industrial production, including plate-fin heat exchangers in such fields as chemical industry, petroleum, coal, electricity, air conditioning and refrigeration. For example, with regard to industrial heat exchangers, the multiscale analysis method and system for thermal-mechanical coupling performance of a heat exchanger can be applied to industrial heat exchangers to predict performance and life of the heat exchangers, and to optimize design and operating conditions of the heat exchangers, thus improving efficiency and reliability of the heat exchangers. With regard to automotive engine cooling systems, the multiscale analysis method and system can also be applied to automotive engine cooling systems to predict strength performance and durability of coolers and to optimize design and operating conditions of the coolers, thus improving engine efficiency and reliability. With regard to aeroengine cooling systems, the multiscale analysis method and system can also be applied to aeroengine cooling systems to predict strength performance and life of coolers, and to optimize design and operating conditions of the coolers, thus improving engine efficiency and reliability. By using the method, it is possible to accurately predict the stress, strain and deformation of the plate-fin heat exchangers due to temperature and cold side and hot side fluid pressure during operation, and determine weak strength zones thereof, thereby improving the strength performance and life of the plate-fin heat exchangers during the design process. Engineers can further use the method and system to carry out strength analysis, fatigue analysis, crack propagation analysis of plate-fin heat exchangers to optimize design schemes and improve performance of plate-fin heat exchanger products. The specific application method comprises: dividing a plate-fin heat exchanger into different zones and extracting channel unit cells according to structural characteristics of an actual heat exchanger; establishing channel unit cell finite element models for respective zones of the heat exchanger; calculating equivalent mechanical parameters of channels in the different zones using different numerical calculation methods according to whether cold side channels and hot side channels satisfy periodic characteristics, and taking the equivalent mechanical parameters as material properties of an actual size plate-fin heat exchanger equivalent solid model; carrying out loading by combining temperature field data and pressure field data to obtain a macroscopic stress field, a strain field and a displacement field of the whole heat exchanger under a combined action of temperature and pressure loads; and determining locations of weak strength zones of the plate-fin heat exchanger and information on a microscopic stress field and a deformation field according to the macroscopic stress field, the strain field and the displacement field to optimize a design scheme of the plate-fin heat exchanger and improve product performance; The method can provide support for the design and optimization of the plate-fin heat exchangers for extreme conditions (very high temperature, very high pressure, and very high vibration) and with extreme performance requirements (weight, volume and heat transfer).

The above merely describes specific embodiments of the present invention, but the protection scope of the present invention is not limited thereto. Any modification, equivalent replacement and improvement made within the spirit and principle of the present invention by any person skilled in the art within the technical scope disclosed in the present invention should be included within the protection scope thereof.

What is claimed is:

1. A multiscale analysis method for thermal-mechanical coupling performance of a heat exchanger, wherein a plate-fin heat exchanger is divided into different zones and channel unit cells are extracted according to structural characteristics of an actual heat exchanger; channel unit cell finite element models are established for respective zones of the heat exchanger; equivalent mechanical parameters of channels in the different zones are calculated using a numerical calculation method according to whether cold side channels and hot side channels satisfy periodic characteristics, and are taken as material properties of an actual size plate-fin heat exchanger equivalent solid model; loading is carried out by combining temperature field and pressure field data to obtain a macroscopic stress field, a strain field and a displacement field of the whole heat exchanger under a combined action of temperature and pressure loads; and locations of weak strength zones of the plate-fin heat exchanger and information on a microscopic stress field and a deformation field are determined according to the macroscopic stress field, the strain field and the displacement field to optimize a design scheme of the plate-fin heat exchanger and improve product performance;
the multiscale analysis method for thermal-mechanical coupling performance of the heat exchanger comprises the following steps:
Step 1, dividing the heat exchanger into an inlet zone, an outlet zone, a core zone and a cover plate zone according to channel structural characteristics of an actual heat exchanger; and extracting a representative channel unit cell for each zone, and constructing channel unit cell finite element models for respective zones of the heat exchanger;
Step 2, dividing the heat exchanger channels into single-type channels and hybrid-type channels, establishing form equations for corresponding equivalent stiffness coefficient matrices or flexibility coefficient matrices with respect to the deformation energy respectively, and calculating equivalent mechanical parameters of the channels in different zones of the heat exchanger by setting a corresponding nodal displacement constraint equation and performing characteristic unit strain or stress loading;
Step 3, establishing a macroscale heat exchanger equivalent solid model, and taking the calculated equivalent mechanical parameters of the channels in the different zones of the heat exchanger as material properties of the heat exchanger equivalent solid model;
Step 4, introducing heat exchanger temperature field data into the heat exchanger equivalent solid model to load a heat exchanger temperature load; setting new equivalent thermal expansion coefficients for equivalent solid models of cold channels and hot channels of the heat exchanger respectively, applying a fixed temperature difference and a uniform pressure to load the pressure load of the heat exchanger, and calculating a macroscopic stress field, a strain field and a displacement field of the whole heat exchanger under a combined action of the temperature load and the pressure load under operating conditions; and
Step 5, determining locations of weak strength zones of the heat exchanger according to calculation results of the macroscopic stress field, the strain field and the displacement field of the heat exchanger equivalent solid model; combining calculation results of unit characteristic stress, strain and temperature field loading of the channel unit cell in each zone of the heat exchanger, and calculating a stress amplification coefficient matrix to obtain the microscopic stress field of mesoscale channels at the locations of the weak strength zones of the heat exchanger;
wherein the Step 2 comprises:
(1) for core zone channels with the same cold and hot channel structure in the heat exchanger which are regarded as the single-type channels with periodic distribution characteristics, by setting a periodic characteristic strain field χ*^{(ij)}, taking the unit characteristic strain field and a strain field caused by unit cell heterogeneity as characteristic strain fields directly applied to a boundary, and obtaining simplified mathematical equations for the equivalent stiffness coefficients of the single-type channels based on form of deformation energy Π;
(2) for inlet and outlet zone channels with different cold and hot channel structures in the heat exchanger which are regarded as the hybrid-type channels with partially periodical distribution characteristics, by setting partial periodic characteristic strain fields χ̊*^{(ij)} and [symbol] respectively, taking the unit characteristic strain field and a unit characteristic stress field as well as the strain field caused by unit cell heterogeneity as characteristic strain fields directly applied to a channel unit cell boundary, and obtaining simplified mathematical equations for an upper limit and a lower limit of the equivalent stiffness coefficients of the hybrid-type channels based on form of deformation energy Π;
(3) for the cover plate zone of the heat exchanger: selecting a substrate and recording material properties of the substrate at different temperatures; and
(4) calculating by the infinite element method the simplified mathematical equations for the equivalent stiffness coefficients of the single-type channels based on form of deformation energy Π and the simplified mathematical equations for the upper limit and the lower limit of the equivalent stiffness coefficients of the hybrid-type channels based on form of deformation energy Π, so as to calculate the equivalent mechanical parameters of the channels in the different zones of the heat exchanger at different temperatures;
the simplified mathematical equations for the equivalent stiffness coefficients of the single-type channels based on form of deformation energy Π are as follows:
diagonal stiffness coefficient
$${D}_{ijij}^{H} = \frac{2}{\vert Y \vert} Π ( {χ}^{* ( ij )} ) ;$$
off-diagonal stiffness coefficient:
$${D}_{iikl}^{H} = \frac{1}{\vert Y \vert} [ Π ( {χ}^{* ( ii )} + {χ}^{* ( kl )} ) - Π ( {χ}^{* ( ii )} ) - Π ( {χ}^{* ( kl )} ) ] ;$$
where χ*^{(ij)} is a periodic unit characteristic strain field, i, j, k, l=1, 2, 3 and are all direction vectors; |Y| is a unit cell volume; and Π is deformation energy;
the simplified mathematical equations for the upper limit and the lower limit of the equivalent stiffness coefficients of the single-type channels based on form of deformation energy Π are as follows:
(2.1) for energy form equations for the upper limit of the equivalent stiffness coefficients:
diagonal stiffness coefficient
$${D}_{ijij}^{H} = \frac{2}{\vert Y \vert} Π ( {\mathring{χ}}^{* ( ij )} ) ;$$
off-diagonal stiffness coefficient
$${D}_{iikl}^{H} = \frac{1}{\vert Y \vert} [ Π ( {\mathring{χ}}^{* ( ii )} + {\mathring{χ}}^{* ( kl )} ) - Π ( {\mathring{χ}}^{* ( ii )} ) - Π ( {\mathring{χ}}^{* ( kl )} ) ] ;$$
where χ̊*^{(ij)} represents a partial periodic unit characteristic strain field, i, j, k, l are all direction vectors with values of 1, 2 and 3; |Y| is a unit cell volume; and Π is deformation energy;
(2.2) for energy form equations for the lower limit of the equivalent stiffness coefficients:
diagonal flexibility coefficient:
$${S}_{ijij}^{H} = \frac{2}{\vert Y \vert} Π ( {{ξ}^{\%}}^{* ( ij )} ) ;$$
off-diagonal flexibility coefficient:
$${S}_{iikl}^{H} = \frac{1}{\vert Y \vert} [ Π ( {{ξ}^{\%}}^{* ( ii )} + {{ξ}^{\%}}^{* ( kl )} ) - Π ( {{ξ}^{\%}}^{* ( ii )} ) - Π ( {{ξ}^{\%}}^{* ( kl )} ) ] ;$$
the lower limit of the equivalent stiffness coefficient: Dᵢⱼₖₗ^{H}=(Sᵢⱼₖₗ^{H})⁻¹,
where [symbol] represents a characteristic strain field corresponding to the partially periodic unit characteristic stress field, i, j, k, l are all direction vectors with values of 1, 2 and 3; |Y| is a unit cell volume; and Π is the deformation energy;
based on this, the equivalent mechanical parameters of the heat exchanger channels are obtained:
$$[ {S}_{ijkl}^{H} ] = [ \begin{matrix}{S}_{1111}^{H} & {S}_{1122}^{H} & {S}_{1133}^{H} & 0 & 0 & 0 \\ {S}_{1122}^{H} & {S}_{2222}^{H} & {S}_{2233}^{H} & 0 & 0 & 0 \\ {S}_{1133}^{H} & {S}_{2233}^{H} & {S}_{3333}^{H} & 0 & 0 & 0 \\ 0 & 0 & 0 & {S}_{1212}^{H} & 0 & 0 \\ 0 & 0 & 0 & 0 & {S}_{1313}^{H} & 0 \\ 0 & 0 & 0 & 0 & 0 & {S}_{2323}^{H}\end{matrix} ] = {[ {D}_{ijkl}^{H} ]}^{- 1} = [ \begin{matrix}\frac{1}{{E}_{x}} & - \frac{{V}_{xy}}{{E}_{x}} & - \frac{{V}_{xz}}{{E}_{x}} & 0 & 0 & 0 \\ - \frac{{V}_{yx}}{{E}_{y}} & \frac{1}{{E}_{y}} & - \frac{{V}_{yz}}{{E}_{y}} & 0 & 0 & 0 \\ - \frac{{V}_{zx}}{{E}_{z}} & - \frac{{V}_{zy}}{{E}_{z}} & \frac{1}{{E}_{z}} & 0 & 0 & 0 \\ 0 & 0 & 0 & \frac{1}{{G}_{xy}} & 0 & 0 \\ 0 & 0 & 0 & 0 & \frac{1}{{G}_{xz}} & 0 \\ 0 & 0 & 0 & 0 & 0 & \frac{1}{{G}_{yz}}\end{matrix} ] ,$$
taking the calculated channel equivalent mechanical parameters of different zones of the heat exchanger as material properties of the heat exchanger equivalent solid model comprises:
taking the calculated equivalent mechanical parameters of the channels in each zone of the heat exchanger as the equivalent material properties of a corresponding zone in the heat exchanger equivalent solid model, and perform matrix direction transformation when the material properties of the different zones are introduced into the macroscale heat exchanger equivalent solid model;
the material properties comprise three equivalent elastic moduli as a function of temperature, three equivalent shear moduli as a function of temperature, and three equivalent Poisson's ratios as a function of temperature;
the Step 4 comprises:
(1) introducing the temperature field data of the heat exchanger into the heat exchanger equivalent solid model to load the heat exchanger temperature load;
(2) setting new equivalent thermal expansion coefficients αₓ^{H}(T) and α_{y}^{H}(T) for the cold and hot channels in an x direction and a y direction of the equivalent solid models of the cold and hot channels respectively, applying a fixed temperature difference ΔT to an overall temperature field of the heat exchanger; wherein the equivalent thermal expansion coefficients are related to the equivalent flexibility coefficient Sᵢⱼₖₗ^{H} of the heat exchanger channels, a flexibility coefficient Sᵢⱼₖₗ of raw materials, temperature T and a heat exchanger channel pressure P;
(3) applying a uniform pressure of value P(1−Ø) to an inlet and outlet cross-section in a z direction and loading an equivalent pressure load of the heat exchanger; wherein Ø represents porosity; and
(4) calculating the macroscopic stress field, the strain field and the displacement field of the whole heat exchanger under the combined action of the temperature load and the pressure load under the operating conditions using the following equation:
$$\{ \begin{matrix}{α}_{x}^{H} ( T ) \\ {α}_{y}^{H} ( T )\end{matrix} \} = {P}_{h , c} \{ \begin{matrix}{S}_{1111}^{H} ( T ) + {S}_{1122}^{H} ( T ) - {S}_{1111} ( T ) - {S}_{1122} ( T ) \\ {S}_{1122}^{H} ( T ) + {S}_{2222}^{H} ( T ) - {S}_{1122} ( T ) - {S}_{2222} ( T ) )\end{matrix} \} / Δ T ;$$
where superscript H represents equivalent; αₓ^{H}(T) and α_{y}^{H}(T) represent the equivalent thermal expansion coefficients in the x direction and the y direction respectively; P_{c} and Pₕ represent a cold side pressure and a hot side pressures respectively, subscripts c and h represent a cold side and a hot side respectively; Sᵢⱼₖₗ^{H} represents the equivalent flexibility coefficient, i, j, k and l represent direction vectors with values of 1, 2 and 3; Sᵢⱼₖₗ represents the equivalent flexibility coefficient of the raw materials; T represents temperature; and ΔT represents the temperature difference.

2. A multiscale analysis system for thermal-mechanical coupling performance of the heat exchanger implementing the multiscale analysis method of thermal-mechanical coupling performance of the heat exchanger according to claim 1, wherein the multiscale analysis system for thermal-mechanical coupling performance of the heat exchanger comprises:
a heat exchanger channel unit cell finite element model construction module configured to divide the heat exchanger into an inlet zone, an outlet zone, a core zone and a cover plate zone according to channel structural characteristics of an actual heat exchanger, and extract a representative channel unit cell for each zone to construct channel unit cell finite element models for respective zones of the heat exchanger;
a heat exchanger channel equivalent mechanical parameter calculation module configured to divide the heat exchanger channels into single-type channels and hybrid-type channels, establish form equations for corresponding equivalent stiffness coefficient matrices or flexibility coefficient matrices with respect to deformation energy respectively, and calculate equivalent mechanical parameters of the channels in different zones of the heat exchanger by setting a corresponding nodal displacement constraint equation and performing characteristic unit strain or stress loading;
a heat exchanger equivalent solid model construction module configured to establish a macroscale heat exchanger equivalent solid model, and take the calculated equivalent mechanical parameters of the channels in the different zones of the heat exchanger as material properties of the heat exchanger equivalent solid model;
a heat exchanger macroscopic stress-strain calculation module configured to introduce heat exchanger temperature field data into the heat exchanger equivalent solid model to load a heat exchanger temperature load, set new equivalent thermal expansion coefficients for equivalent solid models of cold channels and hot channels of the heat exchanger respectively, apply a fixed temperature difference and a uniform pressure to load a pressure load of the heat exchanger, and calculate a macroscopic stress field, a strain field and a displacement field of the whole heat exchanger under a combined action of the temperature load and the pressure load under operating conditions; and
a heat exchanger microscopic stress field calculation module configured to determine locations of weak strength zones of the heat exchanger according to calculation results of the macroscopic stress field, the strain field and the displacement field of the heat exchanger equivalent solid model, combine calculation results of unit characteristic stress, strain and temperature field loading of the channel unit cell in each zone of the heat exchanger, and calculate a stress amplification coefficient matrix to obtain a microscopic stress field of mesoscale channels at the locations of the weak strength zones of the heat exchanger.

3. A computer device, comprising a memory and a processor, the memory storing a computer program which, when executed by the processor, causes the processor to perform the steps of the multiscale analysis method for thermal-mechanical coupling performance of the heat exchanger according to claim 1.

4. A computer-readable storage media storing a computer program which, when executed by a processor, causes the processor to perform the steps of the multiscale analysis method for thermal-mechanical coupling performance of the heat exchanger according to claim 1.

5. An information data processing terminal for implementing a multiscale analysis system for thermal-mechanical coupling performance of the heat exchanger according to claim 2.
